(19) United States
(12) Patent Application Publication
(10) Pub. No.: US 2026/0356147 A1
(43) Pub. Date: Nov. 12, 2026

(54) BALL JOINT FOR A VEHICLE

(71) Applicant: ZF FRIEDRICHSHAFEN AG, Friedrichshafen (DE)

(72) Inventors: Dirk SOKOLIHS, Porta Westfalica (DE); Frank GRUNDMANN, Westerkappeln (DE); Frank HENSEL, Preußisch Oldendorf (DE); Birgit ZUCKER, Stemwede (DE); Stefan WOLTER, Stemshorn (DE)

(21) Appl. No.: 19/135,142

(22) PCT Filed: Oct. 17, 2023
(86) PCT No.: PCT/EP2023/078747

§ 371 Date: Jun. 3, 2025

(30) Foreign Application Priority Data
Dec. 6, 2022 (DE) 10 2022 213 135.5

(51) Int. Cl. B60G 7/00

(52) U.S. Cl. CPC B60G 7/005

(57) ABSTRACT

The invention is directed to a ball joint (20) for a vehicle. The ball joint (20) has a housing (21) and a ball stud (22) which is mounted in the housing (21) so as to be rotationally and swivelably movable and extends out of an opening of the housing (21) by a shaft (23). The opening of the housing (21) is protected against an ingress of foreign matter by a sealing bellows (26) which is arranged coaxial to the ball stud (22) and which has a compressible and stretchable lateral surface. The sealing bellows (26) is circumferentially enclosed by a bellows protection (27). The bellows protection (27) comprises at least two shell elements (28) which are connectable to one another by frictional engagement and which have a convex receiving portion (36) in which the lateral surface of the sealing bellows (26) is received in the joined together position of the shell elements (28) and a substantially annular fastening portion (37) by which the bellows protection (27) encloses a housing-side edge portion of the sealing bellows (26). The shell elements (28) are constructed as identical parts.

The invention is directed to a ball joint for a vehicle according to the preamble of claim 1.

A ball joint for a vehicle of the type mentioned above is known from DE 10 2007 035 654 A1. The ball joint described therein is protected against an ingress of foreign matter by a sealing bellows having a compressible and stretchable lateral surface. Particularly when installing the ball joint in forestry vehicles and/or off-road vehicles, for example, all-terrain vehicles, unimogs, military vehicles, or the like, the sealing bellows is frequently exposed to the risk of external mechanical damage such as by stones or branches, particularly in case of stationary axles. Additionally, the sealing bellows may be exposed to wear as a result of roll motions of the vehicle when the sealing bellows comes into contact with adjacent component parts of the chassis due to the roll motions.

To protect the sealing bellows against damage by external mechanical impacts, DE 10 2007 035 654 A1 provides that the sealing bellows is covered by a separate, tubular protective covering. The protective covering is formed as a loosely braided steel ring mesh or as woven steel fibers or carbon fibers which allows it to conform to the contour of the sealing bellows. The protective covering conforms to the fold pattern of the sealing bellows and is secured in radially inwardly oriented folds of the sealing bellows via outer spring rings, for example, elastic rubber rings. The spring rings can be torn away from the protective covering, for example, by branches, in driving operation, particularly in off-road driving operation. Further, the protective covering must be fixed in position at the stud-side end thereof by means of a clamping ring so as not to slip off of the sealing bellows due to its own mass. The connection of the protective covering to the clamping ring is complicated because the rings of the steel ring mesh on the stud-end side must be fitted onto the clamping ring individually. There is a tendency in both the steel ring mesh and the steel fiber fabric or carbon fiber fabric to collect dirt or for dirt to be embedded therein, particularly in off-road driving operation. Exchanging the protective covering is very cumbersome because the ball joint must be disassembled for this purpose.

A ball joint for a vehicle which is formed to protect a sealing bellows with a bellows protection partially enclosing the sealing bellows is known from DE 10 2016 201 046 A1. The bellows protection which partially encloses the sealing bellows in an encircling region, particularly the region of the compressible and stretchable lateral surface of the sealing bellows, is bonded to the sealing bellows. Apart from the effort in disassembling the ball joint which is required when it is necessary to exchange the bellows protection, this involves exchanging the sealing bellows. The bellows protection constitutes a partial thickening of the sealing bellows. The bellows protection and the sealing bellows are made from the same material so that the effect on the elasticity of the sealing bellows is only minor.

Proceeding from the prior art described above, the present invention has the object of further developing a ball joint of the type mentioned above which is characterized by an improved bellows protection.

This object is met by a ball joint for a vehicle proceeding from the preamble of claim 1 in connection with the characterizing features thereof. The dependent claims proceeding from claim 1 show advantageous further developments of the invention.

A ball joint for a vehicle is suggested according to claim 1. The ball joint has a housing and a ball stud which is mounted in the housing so as to be rotationally and swivelably movable, a shaft of which ball stud extends out of an opening of the housing, and the opening of the housing is protected against an ingress of foreign matter by a sealing bellows which is arranged coaxial to the ball stud and which has a compressible and stretchable lateral surface and is circumferentially enclosed by a bellows protection. It is provided according to the invention that the bellows protection comprises at least two shell elements which are connectable to one another by frictional engagement and which have a convex receiving portion in which the lateral surface of the sealing bellows is received in the joined together position of the shell elements and a substantially annular fastening portion by which the bellows protection encloses a housing-side edge portion of the sealing bellows. The shell elements are constructed as identical parts. The advantage in forming the bellows protection so as to comprise at least two parts consists in that it is mountable around the sealing bellows, particularly also retroactively, without requiring prior disassembly of the ball joint or sealing bellows. The convex receiving portion in which the lateral surface of the sealing bellows is received in the joined together position of the shell elements encloses the lateral surface with its inner surface oriented toward the lateral surface in a substantially contact-free manner. Viewed in cross section, the convex receiving portion has a radial profile such that a contact-free region is formed between the lateral surface and the inner surface of the enclosing receiving portion, particularly in the undeflected state of the ball joint. The construction of the shell elements as identical parts reduces production costs. Further, assembly errors can be countered in this way. The key function of the bellows protection is to protect the sealing bellows arranged therein from foreign matter leading to mechanical wear. At the same time, the bellows protection itself undergoes wear, which can make it necessary to exchange the bellows protection on a regular basis. Exchange is simplified compared to the prior art by the at least two-part construction of the bellows protection, since the at least two shell elements may be detached from the ball joint without having to disassemble the latter as would be the case in the prior art.

In particular, the respective shell element can have joining portions at its free ends, which joining portions extend partially in circumferential direction and on which frictional engagement elements are arranged.

To this end, the joining portions of the respective shell element can be formed in a complementary manner. The joining portions can overlap one another over the entire surface in the joined position of the shell elements. The overlapping joining portions terminate substantially flush with one another. In this way, significant projections which promote deposits of dirt can be prevented from forming on the outer side of the joined together bellows protection.

In particular, one joining portion may be formed at the inner wall of the shell element and the other joining portion may be formed at the outer wall of the shell element. By “formed at the inner wall” is meant the position on the inner surface of the respective shell element oriented to the sealing bellows. Correspondingly, “formed at the outer wall” refers to the position on the outer surface of the respective shell element oriented away from the sealing bellows.

Preferably, the frictional engagement elements of the one joining portion can be arranged at the inner wall, and the frictional engagement elements of the other joining portion can be arranged at the outer wall.

According to a further development, the wall thickness of the joining portions can be less than the wall thickness of a region of the receiving portion extending in circumferential direction between the joining portions. In particular, the wall thickness of the joining portions corresponds to one half of the wall thickness of the region extending in circumferential direction between the joining portions.

Alternatively, the wall thickness of the joining portions can be identical to the wall thickness of a region of the receiving portion extending in circumferential direction between the joining portions. The reduction in the wall thickness of the region extending in circumferential direction between the joining portions can increase the elasticity of the bellows protection. Accordingly, the bellows protection can also yield elastically during a lateral deflection of the ball stud.

The extension of the joining portions arranged at the inner wall and outer wall in circumferential direction of the shell element can be limited by a butt edge which is formed between the respective joining portion and the region and which extends in tangential direction of the shell element. The butt edges can form a stop which limits the path to be covered in radial direction by the two shell elements when joining them together.

Further, the butt edges can have correspondingly constructed radial abutment faces which are oriented toward the joining portion and which extend in tangential direction at least over the entire receiving portion. The shell elements in joined position can contact one another, preferably so as to be flush, at the radial abutment faces. The abutment faces preferably also extend in axial direction along the extension of the fastening portion.

In particular, the correspondingly constructed abutment faces can extend vertical to or at an inclination to the surface of the joining portion.

According to a further development, the radial abutment faces can have an undercut which can be brought into positive engagement with a projection at the end of the complementary joining portion of the other shell element.

The frictional engagement elements can preferably extend partially in tangential direction of the respective joining portion and can be formed to narrow in diameter in radial direction. The advantage in forming the frictional engagement elements to narrow in diameter radially consists in that the joining portions can better slide over one another when joining the shell elements together.

In particular, the frictional engagement elements can be formed to narrow in diameter in tangential direction.

The frictional engagement elements can preferably extend in tangential direction of the receiving portion proceeding from an edge area defining a shaft-side opening.

In particular, the shell elements can comprise a plastics material, particularly polyurethane (PUR).

The plastics material can preferably have a Shore hardness of greater than 75 and less than 100, preferably less than 90. The use of plastics material in this material hardness range is particularly suitable for achieving a sufficient wear behavior on the one hand and ensuring a sufficient elasticity on the other hand, so that the bellows protection has a sufficient compliance during a deflection of the ball joint.

The invention is not limited to the indicated combination of features of the independent claims or of the claims dependent thereon. Further, it is also possible to combine individual features, as far as they arise from the claims, from the following description of preferred embodiment forms of the invention or directly from the drawings. When the claims refer to the drawings through the use of reference numerals, this is not intended to limit the protective scope of the claims.

An advantageous embodiment form of the invention which will be explained in the following is shown in the drawings. The drawings show:

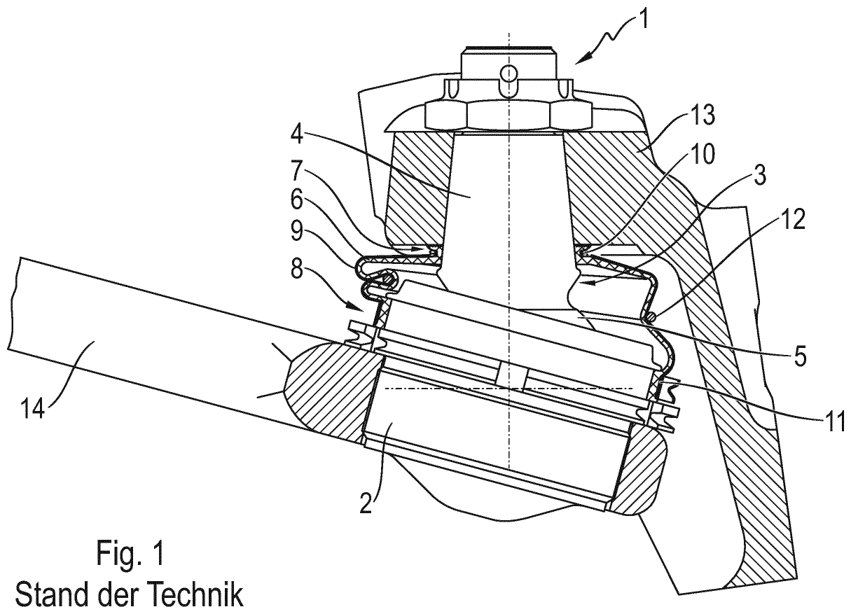

FIG. 1 a schematic diagram of a ball joint according to the prior art;

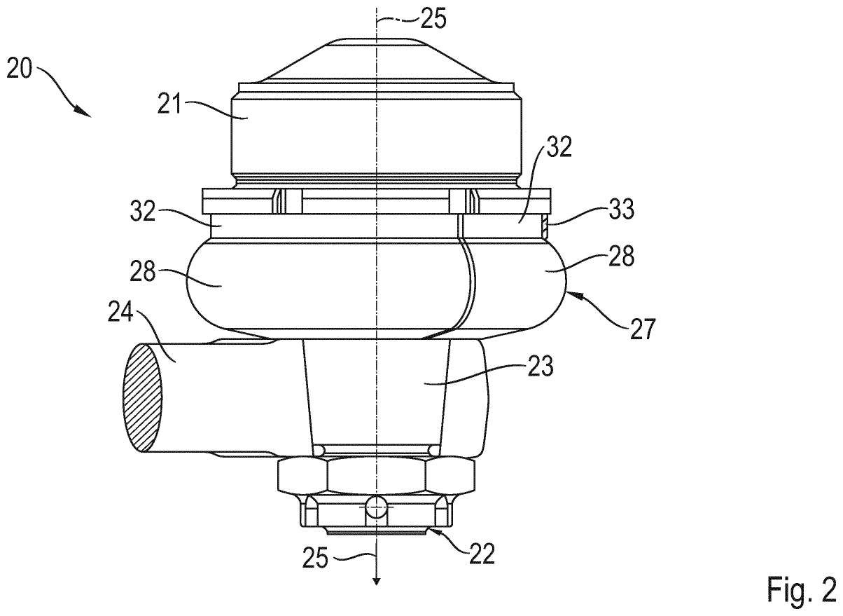

FIG. 2 a view of a ball joint according to the invention;

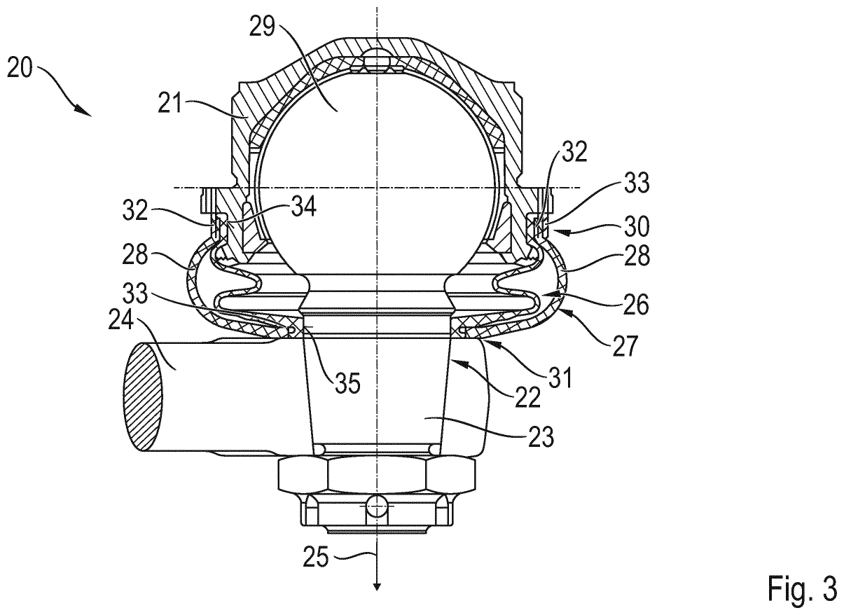

FIG. 3 a partial sectional view of the ball joint according to FIG. 2;

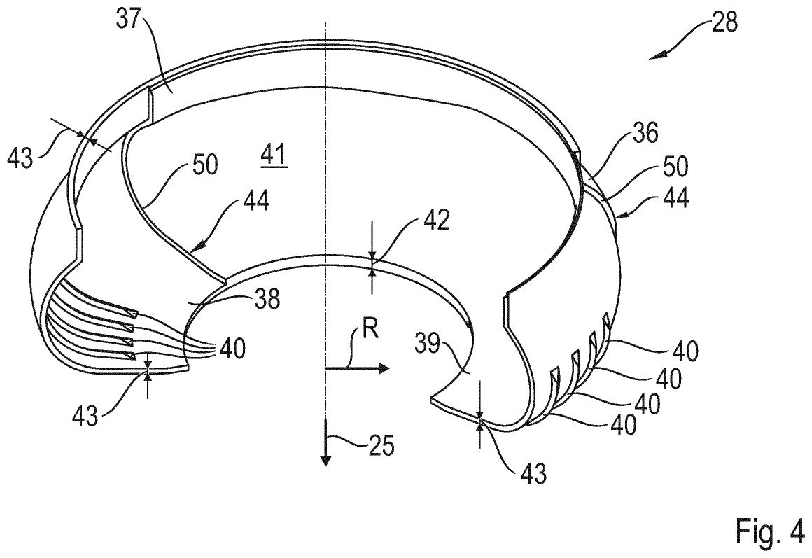

FIG. 4 a perspective view of a shell element of a bellows protection;

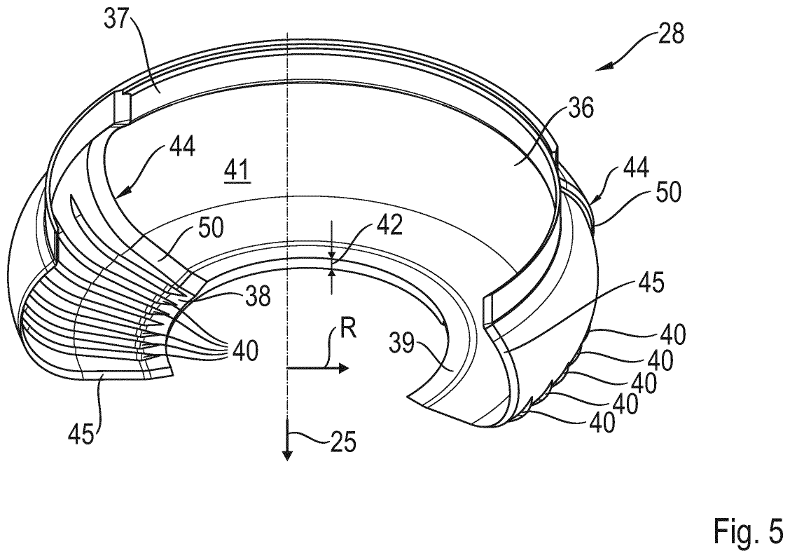

FIG. 5 a perspective view of a shell element of the bellows protection according to a further embodiment form;

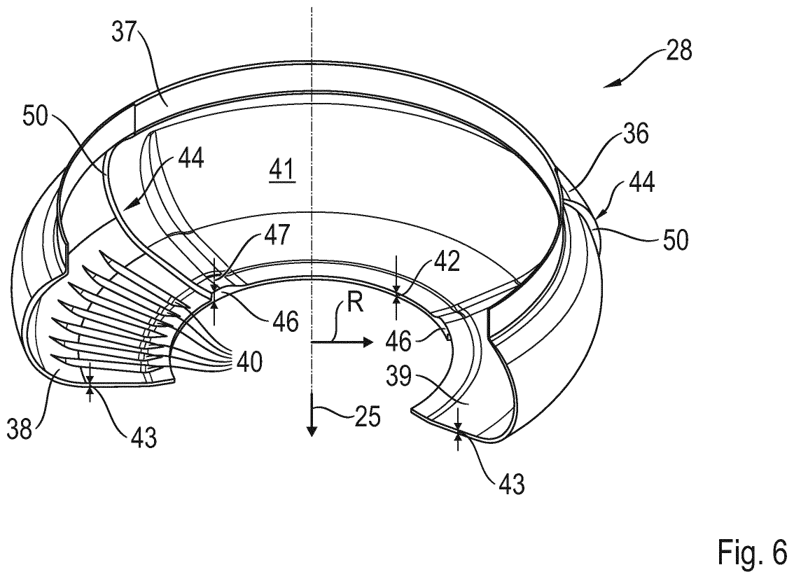

FIG. 6 a perspective view of a further development of the shell element according to FIG. 4; and

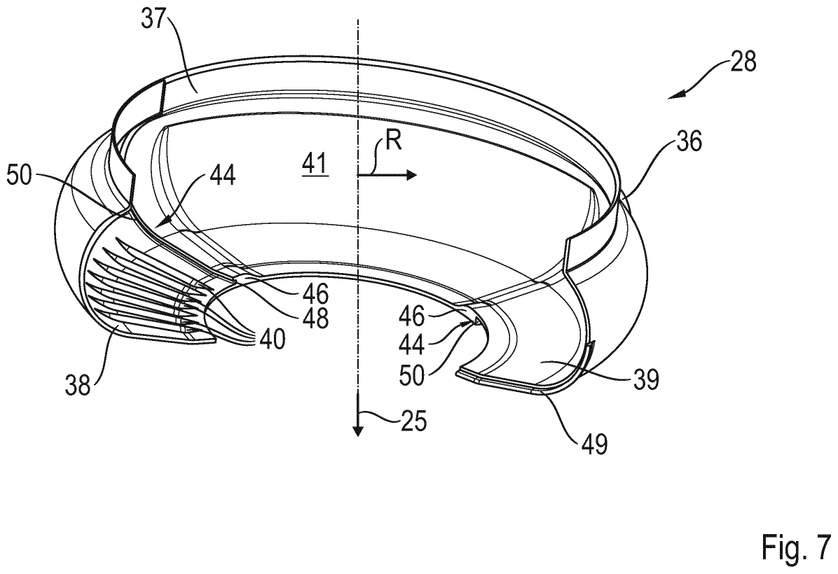

FIG. 7 a perspective view of the shell element according to a further development according to FIG. 6.

FIG. 1 shows a ball joint 1 known from the prior art which is formed as a support joint, as it is called. The ball joint 1 has a housing 2 and a ball stud 3 mounted in the housing 2 so as to be rotationally movable and swivelably movable. The ball stud 3 extends out of an opening of the housing 2 and has a conical shaft 4 and a joint ball 5 which is arranged inside of the housing 2. The opening of the housing 2 is protected against unwanted ingress of dirt and/or moisture by a sealing bellows 6. The sealing bellows 6 has a stud-side end 7 which contacts the conical outer circumferential surface of the shaft 4 and a housing-side end 8 which is secured to the outer circumference of the housing 2. In order to protect the sealing bellows 6 against damage due to external mechanical impacts, the sealing bellows 6 is completely enclosed by a tubular bellows protection 9. The bellows protection 9 is secured to the sealing bellows 6 at the stud-side end 7 of the sealing bellows 6 by a clamping ring 10. At the housing-side end 8 of the sealing bellows 6, the bellows protection 9 is secured to the sealing bellows 6 by a clamping band 11. In a waisted inwardly curved portion of the sealing bellows 6, the bellows protection 9 is pressed against the sealing bellows 6 by a spring ring 12. The ball joint 1 is linked to a wheel carrier 13 via the shaft 4 and to a control arm 14 via the housing 2.

FIG. 2 shows a ball joint 20 according to the invention for a vehicle. The ball joint 20 has a housing 21 and a ball stud 22 which is mounted in the housing 21 so as to be rotationally movable and swivelably movable. The ball stud 22 extends out of an opening of the housing 21 by a shaft 23. The ball joint 20 is connected by the shaft 23 to a control arm 24. The rotational axis of the ball stud 22 which is shown in the undeflected position coincides with an axial direction of the ball joint 20 designated by reference numeral 25.

Foreign matter, particularly dirt and moisture, is prevented from entering the opening of the housing 21 by a sealing bellows 26, as is shown in FIG. 3, which has a compressible and stretchable lateral surface and is arranged coaxial to the ball stud 22. The sealing bellows 26 is circumferentially enclosed by a bellows protection 27. The bellows protection 27 comprises at least two shell elements 28 which are connectable to one another in a frictionally engaging manner. The shell elements 28 are constructed as identical parts. The bellows protection 27 is constructed to be rotationally symmetrical.

FIG. 3 is a partly sectional view of the ball joint 20 according to FIG. 2. The ball stud 22 has a joint ball 29 which is arranged inside of the housing 21. The joint ball 29 is rotationally movably and swivelably movably mounted in the housing 21 by means of a bearing shell.

In order to prevent mechanical damage to the sealing bellows 26, the sealing bellows 26 is enclosed, particularly in its entirety, by the at least two-part bellows protection 27. The sealing bellows 26 contacts the housing 21 by an end 30 on the housing side. The housing-side end 30 of the sealing bellows 26 is annularly enclosed in axial direction 25 by an encirclement region 32 of the bellows protection 27. The sealing bellows 26 and the bellows protection 27 are enclosed in this encirclement region 32 by clamping means 33 formed as a clamping band or clamping ring and jointly pressed against a circumferential abutment region 34 of the housing 21. A stud-side end 31 of the sealing bellows 26 facing the shaft 23 of the ball stud 22 contacts the conical outer circumferential surface of the shaft 23. Clamping means 33 are also provided at the stud-side end 31 of the sealing bellows 26 in order to press the sealing bellows 26 against a circumferential abutment region 35 of the shaft 23.

Since the shell elements 28 of the bellows protection 27 are constructed as identical parts, further description of the shell elements 28 will be based in the following only on one shell element 28 shown in FIGS. 4 to 7. Accordingly, the description applies to the at least one further shell element 28 of the bellows protection 27. Identical reference numerals are used for identical or identically constructed components of the shell elements 28 described in the following.

FIG. 4 is a perspective view of one of the two shell elements 28 of the bellows protection 27.

The shell element 28 has a convex receiving portion 36 in which the lateral surface of the sealing bellows 26 is received in joined together position of the shell elements 28. In the undeflected position of the ball stud 22 shown in FIG. 2, the convex receiving portion 36 of the shell element 28 is spaced from the lateral surface of the sealing bellows 26 in radial direction R. Accordingly, a virtually contactless arrangement of the bellows protection 27 enclosing the sealing bellows 26 is achieved in the region of the convex receiving portion 36.

Further, the shell element 28 has a substantially annular fastening portion 37 extending in axial direction 25. The joined together bellows protection 27 encloses a housing-side edge portion at the housing-side end 30 of the sealing bellows 26 in circumferential direction with the fastening portion 37. The fastening portion 37 is part of the encirclement region 32.

In order to assemble the bellows protection 27, the shell elements 28 are joined together. To this end, the respective shell element 28 has at its free ends joining portions 38, 39 partially extending in circumferential direction. Frictional engagement elements 40 are arranged on the joining portions 38, 39. Frictional engagement elements 40 are preferably identically constructed. The identically constructed and complementary shell elements 28 can be joined in the manner of a plug-in connection.

Joining portions 38, 39 of the respective shell element 28 are formed in a complementary manner. To this end, the one joining portion 38 is formed at the inner wall of the shell element 28 and the other joining portion 39 is formed at the outer wall of the shell element 28. Forming of the joining portion 38 at the inner wall means the position on the inner surface of the respective shell element 28 oriented toward the sealing bellows 26. Correspondingly, forming the joining portion 39 at the outer wall refers to the position on the outer surface of the respective shell element 28 oriented away from the sealing bellows 26.

Joining portions 38, 39 extend in tangential direction over the entire extent of the receiving portion 36 and of the adjoining fastening portion 37. The free ends of the joining portions 38, 39 enclose an angle of less than 180° therebetween.

The frictional engagement elements 40 of the inner-wall joining portion 38 are arranged on the inner side, and the frictional engagement elements 40 of the outer-wall joining portion 39 are arranged on the outer side.

Frictional engagement elements 40 extend partially in tangential direction of the respective joining portion 38, 39. Frictional engagement elements 40 are formed to narrow in diameter in radial direction R. Frictional engagement elements 40 are preferably constructed as ribs. Frictional engagement elements 40 are arranged equidistant from one another in particular. Frictional engagement elements 40 have a substantially triangular cross section. Frictional engagement elements 40 are preferably arranged equidistant from one another.

At least four frictional engagement elements 40 are preferably arranged on the respective joining portion 38, 39. Frictional engagement elements 40 of the joining portions 38, 39 of the joined together shell elements 28, which joining portions 38, 39 are arranged one above the other, mesh with one another in the manner of splines. Accordingly, it can be ensured that vibrations do not lead to unwanted disengagement of the frictionally engaging connection of the two shell elements 28.

A region 41 of the receiving portion 36 extending in circumferential direction is located between the inner-wall joining portion 38 and the outer-wall joining portion 39. Region 41 has a wall thickness 42 which is greater than a respective wall thickness 43 of the adjoining joining portions 38, 39. In the depicted embodiment example, the wall thickness 43 of the adjoining joining portions 38, 39 corresponds to one half of the wall thickness 42 of region 41. Accordingly, in the position of the shell elements 28 in which the latter are joined together to form the bellows protection 27, there is a uniform wall thickness that remains constant in circumferential direction, this uniform wall thickness corresponding to wall thickness 42 of region 41. The wall thickness 43 of the joining portions 38, 39 is preferably the same in the receiving portion 36 and in the adjacent fastening portion 37.

The extension of the joining portions 38, 39 formed at the inner wall and at the outer wall is limited in circumferential direction of the shell element 28 by a butt edge 44 which is formed between the respective joining portion 38, 39 and region 41 and which extends in tangential direction of the shell element 28. The respective butt edge 44 has abutment faces 50 extending in radial direction R perpendicular to the surface of the joining portion 38 and 39, respectively. In the joined together position of the shell elements 28, the butt edges 44 are located opposite one another. The abutment faces 50 contact one another.

As a result of the construction of the shell element 28 shown in FIG. 4, an outer lateral surface of the bellows protection 27 which terminates in a substantially flush manner in the joined together position of the shell elements 28 is achieved. Accordingly, unwanted deposits in the area of the tangentially extending outside butt edges 44 are prevented.

FIG. 5 is a perspective view of one of the shell elements 28 of the bellows protection 27 according to a further embodiment form. The substantially rib-shaped frictional engagement elements 40 are constructed so as to terminate in a tapering manner at the ends in tangential direction. As is also the case with the frictional engagement elements 40 according to the construction shown in FIG. 4, the frictional engagement elements 40 extend in tangential direction substantially over the entire extent of the receiving portion 36 viewed in axial direction 25. Bevels 45 are provided at the free ends of the joining portions 38, 39. The bevels 45 at the free ends of the joining portions 38, 39 can facilitate the joining together of the at least two shell elements 28 when assembling around the sealing bellows 26. Further, the abutment faces 50 of the butt edges 44 have a profile inclined by 45° in particular. Another difference consists in that there is a larger quantity of frictional engagement elements 40 which are arranged on the respective joining portion 38, 39.

FIG. 6 is a perspective view of a further development of the shell element 28 according to FIG. 4. According to this further development, it is provided that the wall thickness 42 of the region 41 of the receiving portion 36 extending in circumferential direction between the inner-wall joining portion 38 and the outer-wall joining portion 39 substantially corresponds to the wall thickness 43 of the respective joining portion 38, 39 of the shell element 28. Whereas a doubling of the wall thickness 43 occurs as result of the overlapping joining portions 38, 39 of the at least two shell elements 28 in the position of the shell elements 28 in which the latter are joined together to form the bellows protection 27, the regions 41 of the at least two shell elements 28 have a single wall thickness 42. This has the effect that the bellows protection 27 is more flexible or elastic within regions 41.

To this end, a transition portion 46 is formed proceeding from the abutment face 50 of the respective butt edge 44, which transition portion 46 extends partially in circumferential direction of the shell element 28. The transition portion 46 extends in tangential direction from the inner edge of the shell element 28 to the fastening portion 37. The transition portion 46 is constructed so as to narrow in diameter in circumferential direction such that there is a wall thickness profile which has a wall thickness 47 in the area of the butt edge 44 that corresponds to twice the wall thickness of the respective joining portion 38, 39. The respective wall thickness profile of the transition regions 46 decreases toward the region 41 located between the butt edges 44.

The rib-shaped frictional engagement elements 40 are formed analogous to the frictional engagement elements 40 shown in FIG. 5. However, the frictional engagement elements 40 of the shell element 28 which are shown in FIG. 6 have a tangential extension which corresponds to approximately one half of the tangential extension of the respective joining portion 38, 39.

FIG. 7 is a perspective view of the shell element 28 according to a further development according to FIG. 6. The shell element 28 shown in FIG. 7 differs in that the abutment face 50 of the butt edge 44 of the inner-wall joining portion 38 is modified. The abutment face 50 of butt edge 44 is constructed with an undercut 48 which extends in tangential direction partially along the receiving portion 36. A projection 49 is formed at the free and of the outer-wall joining portion 39. The projection 49 is formed to complement the undercut 48 in the abutment face 50 so that the latter engage in one another in a positively engaging manner in the joined position of the shell elements 28.

The embodiment form of the individual shell elements 28 notwithstanding, the basic task of the bellows protection 27 formed by the at least two joined-together shell elements 28 is to protect the sealing bellows 26 against foreign matter and, in particular, against foreign bodies such as stones, branches, or the like, so that the lifetime of the ball joint 20 as a whole can be prolonged. In this regard, it is particularly advantageous that the bellows protection 27 formed of at least two parts can be assembled and disassembled without having to uninstall the ball joint 20.

The shell elements 28 comprise a plastics material, particularly polyurethane. The plastics material used for production can have a Shore hardness of greater than 75 and less than 100, particularly less than 90.

### REFERENCE NUMERALS

1 ball joint
2 housing
3 ball stud
4 shaft
5 joint ball
6 sealing bellows
7 stud-side end of 6
8 housing-side end of 6
9 bellows protection
10 clamping ring
11 clamping band
12 spring ring
13 wheel carrier
14 control arm
20 ball joint
21 housing
22 ball stud
23 shaft
24 control arm
25 axial direction
26 sealing bellows
27 bellows protection
28 shell element
29 joint ball
30 housing-side end of 27
31 stud-side end of 27
32 encirclement region
33 clamping means
34 abutment region of 21
35 abutment region of 23
36 receiving portion
37 fastening portion
38 joining portion
39 joining portion
40 frictional engagement element
41 region
42 wall thickness
43 wall thickness
44 butt edge
45 bevel
46 transition portion
47 wall thickness
48 undercut
49 projection
50 abutment face of 44

1-16. (canceled)

17. A ball joint for a vehicle, comprising:
a housing;
a ball stud rotationally and swivelably mounted in the housing with a shaft that extends out of an opening of the housing;
a sealing bellows arranged coaxial to the ball stud and which has a compressible and stretchable lateral surface and s configured to protect the opening of the housing against an ingress of foreign matter; and
a bellows protection that circumferentially the sealing bellows and comprises:
at least two shell elements which are connectable to one another by frictional engagement and which have a convex receiving portion in which a lateral surface of the sealing bellows is received in a joined together position of the at least two shell elements; and
a substantially annular fastening portion by which the bellows protection encloses a housing-side edge portion of the sealing bellows,
wherein the at least two shell elements are constructed as identical parts.

18. The ball joint according to claim 17, wherein each respective shell element has joining portions at its free ends, the joining portions (38, 39) extend partially in circumferential direction and on which frictional engagement elements are arranged.

19. The ball joint according to claim 18, wherein the joining portions of the respective shell element are formed in a complementary manner.

20. The ball joint according to claim 19, wherein a first of the joining portions is formed at an inner wall of the shell elements and a second of the joining portions is formed at an outer wall of the shell elements.

21. The ball joint according to claim 18, wherein the frictional engagement elements of one of the joining portions are arranged at an inner wall, and the frictional engagement elements of an other joining portions are arranged at an outer wall.

22. The ball joint according to claim 18, wherein the joining portions have a wall thickness that is less than a wall thickness of a region of the convex receiving portion extending between the joining portions in circumferential direction.

23. The ball joint according to claim 18, wherein the joining portions have a wall thickness that is identical to a wall thickness of a region of the convex receiving portion extending between the joining portions in circumferential direction.

24. The ball joint according to claim 22, wherein an extension of the joining portions arranged at an inner wall and an outer wall in circumferential direction of the shell elements is limited by a butt edge which is formed between the respective joining portion and a region and which extends in tangential direction of the shell elements.

25. The ball joint according to claim 24, wherein the butt edges have correspondingly constructed radial abutment faces which are oriented toward the joining portions and which extend in tangential direction at least over an entire receiving portion.

26. The ball joint according to claim 25, wherein the correspondingly constructed abutment faces extend vertical to or at an inclination to a surface of the joining portion.

27. The ball joint according to claim 25, wherein the radial abutment faces of one of the joining portion has an undercut which can be brought into positive engagement with a projection at a free end of the complementary joining portion of the other shell element.

28. The ball joint according to claim 18, wherein the frictional engagement elements extend partially in tangential direction of the respective joining portion and are formed to narrow in diameter in radial direction.

29. The ball joint according to claim 18, wherein the frictional engagement elements are formed to narrow in diameter in tangential direction.

30. The ball joint according to claim 18, wherein the frictional engagement elements extend in tangential direction of the receiving portion proceeding from an edge area defining a shaft-side opening.

31. The ball joint according to claim 17, wherein the shell elements comprise a plastics material.

32. The ball joint according to 15, wherein the plastics material has a Shore hardness of greater than 75 and less than 100.

33. The ball joint according to claim 23, wherein an extension of the joining portions arranged at an inner wall and an outer wall in circumferential direction of the shell element is limited by a butt edge which is formed between the respective joining portion and a region and which extends in tangential direction of the shell element.

34. The ball joint according to claim 31, wherein the plastics material is polyurethane.

35. The ball joint according to 16, wherein the plastics material has a Shore hardness of less than 90.
